(19) United States
(12) Patent Application Publication
(10) Pub. No.: US 2022/0067585 A1
(43) Pub. Date: Mar. 3, 2022

(54) METHOD AND DEVICE FOR IDENTIFYING MACHINE LEARNING MODELS FOR DETECTING ENTITIES

(71) Applicant: L&T TECHNOLOGY SERVICES LIMITED, Chennal (IN)

(72) Inventors: MRIDUL BALARAMAN, Bangalore (IN); MADHUSUDAN SINGH, Bangalore (IN); MRINAL GUPTA, Jammu (IN); VIDYA SURESH, Bangalore (IN); KARTIK NIVRITTI KADAM, Hyderabad (IN); NIRMAL VENKATA RAMESH RAYULU VANAPALLI, Hyderabad (IN)

(21) Appl. No.: 17/419,441

(22) PCT Filed: Dec. 30, 2019
(86) PCT No.: PCT/IB2019/061432

§ 371 Date: Jun. 29, 2021

(30) Foreign Application Priority Data
Dec. 31, 2018 (IN) 201841050032

(51) Int. Cl. G06N 20/00; G06K 9/46

(52) U.S. Cl. CPC G06N 20/00; G06K 2209/01; G06K 9/46

(57) ABSTRACT

A method and device for identifying machine learning models for detecting entities is disclosed. The method includes identifying a first entity from within data. A machine learning model trained to identify the first entity is absent in a plurality of machine learning models. The method may include extracting a first set of entity attributes associated with the first entity and matching the first set of entity attributes with each of a plurality of second set of entity attributes. The method may further comprises identifying a second entity from the set of second entities based on the matching. Similarity between a second set of entity attributes associated with the second entity and the first set of entity attributes is above a similarity threshold. The method may include retraining a machine learning model associated with the second entity to identify the first entity based on the first set of entity attributes.

### TECHNICAL FIELD

This disclosure relates generally to machine learning models, and more particularly to method and device for identifying machine learning models for detecting entities.

### BACKGROUND

Digital data (for example, digital images) may be highly inconsistent and may depend on various factors. For digital images, these factors may include, but are not limited to image resolution, noise effect, or font size. Training a machine learning model to identify entities from digital data with high level of accuracy (for example, by performing Optical Character Recognition (OCR)) is challenging.

In conventional techniques, user may define machine learning models for identifying predefined entities. However, as and when a new entity is encountered during an OCR process, a user may need to create or define a new machine learning model for identifying the new entity. Such process of creating a new machine learning model, each time a new entity is encountered, is time consuming and may require various complex calculations.

There is therefore a need for an automated method to build new machine learning models for newly identified entities.

### SUMMARY

In one embodiment, a method for identifying a machine learning model for detecting entities from data is disclosed. The method may include identifying a first entity from within data, wherein a machine learning model trained to identify the first entity is absent in a plurality of machine learning models, wherein each of the plurality of machine learning models is trained to identify at least one entity from a set of second entities. The method may further include extracting a first set of entity attributes associated with the entity. The method may include matching the first set of entity attributes with each of a plurality of second set of entity attributes extracted for the set of second entities. The method may further include identifying a second entity from the set of second entities based on the matching, wherein similarity between a second set of entity attributes associated with the second entity and the first set of entity attributes is above a similarity threshold. The method may include retraining a machine learning model associated with the second entity to identify the first entity based on the first set of entity attributes.

In another embodiment, an entity detection device for identifying a machine learning model for detecting entities from data is disclosed. The entity detection device includes a processor and a memory communicatively coupled to the processor, wherein the memory stores processor instructions, which, on execution, cause the processor to identify a first entity from within data, wherein a machine learning model trained to identify the first entity is absent in a plurality of machine learning models, wherein each of the plurality of machine learning models is trained to identify at least one entity from a set of second entities. The processor instructions further cause the processor to extract a first set of entity attributes associated with the entity. The processor instructions cause the processor to match the first set of entity attributes with each of a plurality of second set of entity attributes extracted for the set of second entities. The processor instructions further cause the processor to identify a second entity from the set of second entities based on the matching, wherein similarity between a second set of entity attributes associated with the second entity and the first set of entity attributes is above a similarity threshold. The processor instructions cause the processor to retrain a machine learning model associated with the second entity to identify the first entity based on the first set of entity attributes.

A non-transitory computer-readable storage medium comprising a set of computer-executable instructions causing a computer comprising one or more processors to perform steps comprising identifying a first entity from within data, wherein a machine learning model trained to identify the first entity is absent in a plurality of machine learning models, wherein each of the plurality of machine learning models is trained to identify at least one entity from a set of second entities; extracting a first set of entity attributes associated with the entity; matching the first set of entity attributes with each of a plurality of second set of entity attributes extracted for the set of second entities; identifying a second entity from the set of second entities based on the matching, wherein similarity between a second set of entity attributes associated with the second entity and the first set of entity attributes is above a similarity threshold; and retraining a machine learning model associated with the second entity to identify the first entity based on the first set of entity attributes.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a system for identifying or creating a machine learning model for detecting new entities, in accordance with an embodiment.

FIG. 2 is a functional block diagram of various modules within a memory of an entity identification device configured to identify machine learning model for detecting new entities, in accordance with an embodiment.

FIG. 3 illustrates a flowchart of a method for identifying an existing machine learning model and retraining the existing machine learning model for detecting new entities, in accordance with an embodiment.

FIG. 4 illustrates a flowchart of a method for identifying an existing machine learning model or creating a new machine learning model for detecting new entities, in accordance with an embodiment.

FIG. 5 illustrates a flowchart of a method for determining accuracy of a machine learning model and accordingly retaining or retraining the retrained machine learning model, in accordance with an embodiment.

FIG. 6 illustrates a block diagram of an exemplary computer system for implementing various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

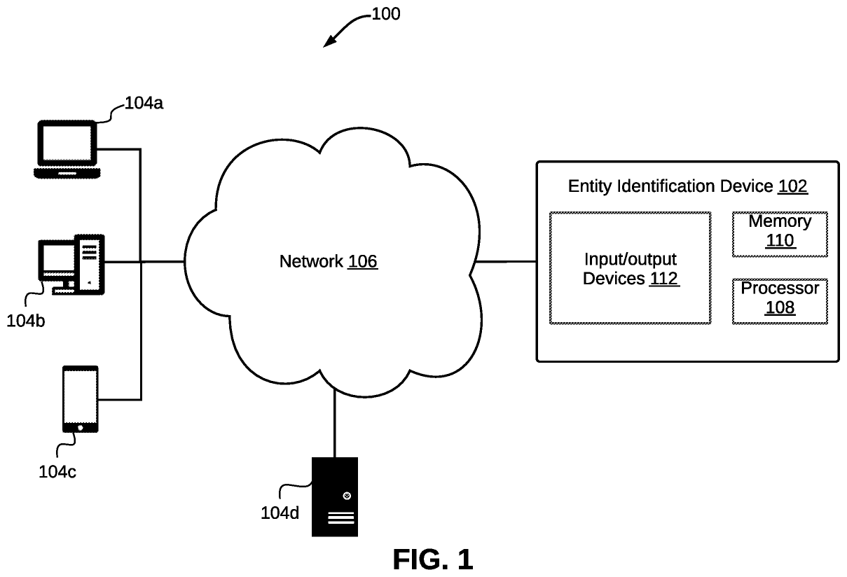

In one embodiment, a system 100 for identifying or creating a machine learning model for detecting new entities is illustrated in the FIG. 1, in accordance with an embodiment. The system 100 may include an entity identification device 102 and a plurality of computing devices 104. The entity identification device 102 may be a computing device having data processing capability. Examples of the entity identification device 102 may include, but are not limited to a server, a desktop, a laptop, a notebook, a netbook, a tablet, a smartphone, a mobile phone, an application server, a sever, or the like. In particular, the entity identification device 102 may have the capability to identify an existing machine learning model or create a new machine learning models to identify new entities within data. The data, for example, may include, but is not limited to images, text, or sensor data. The entities, for example, may include one or more of, but are not limited to a character, an animal, an object, or a human.

Further, examples of the plurality of computing devices 104 may include, but are not limited to a laptop 104a, a computer 104b, a smart phone 104c, and a server 104d. The entity identification device 102 is in communication with the plurality of computing devices 104 via a network 106. The network 106 may be a wired or a wireless network and the examples may include, but are not limited to the Internet, Wireless Local Area Network (WLAN), Wi-Fi, Long Term Evolution (LTE), Worldwide Interoperability for Microwave Access (WiMAX), and General Packet Radio Service (GPRS). One or more of the plurality of computing devices 104 may provide data to the entity identification device 102, in order to identify one or more new entities from within the data so provided.

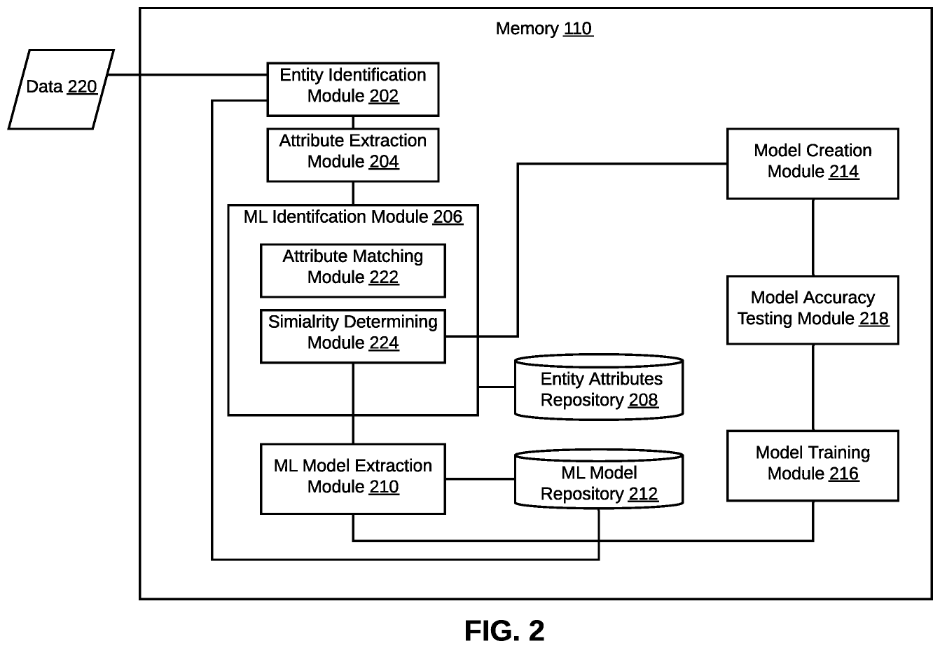

In order to identify or create a machine learning model for identifying new entities within data, the entity identification device 102 may include a processor 108 and a memory 110. The memory 110 may store instructions that, when executed by the processor 108, may cause the processor 108 to identify or create a machine learning model for identifying new entities, as discussed in greater detail in FIG. 2 to FIG. 5. The memory 110 may be a non-volatile memory or a volatile memory. Examples of non-volatile memory, may include, but are not limited to a flash memory, a Read Only Memory (ROM), a Programmable ROM (PROM), Erasable PROM (EPROM), and Electrically EPROM (EEPROM) memory. Examples of volatile memory may include, but are not limited to Dynamic Random Access Memory (DRAM), and Static Random-Access memory (SRAM).

The entity identification device 102 may further include one or more input/output devices 112 through which the entity identification device 102 may interact with a user and vice versa. By way of an example, the input/output devices 114 may be used to render identified entities to a user. The input/output devices 112, for example, may include a display.

Referring now to FIG. 2, a functional block diagram of various modules within the memory 110 of the entity identification device 102 configured to identify machine learning model for detecting new entities is illustrated, in accordance with an embodiment. The modules include an entity identification module 202, an attribute extraction module 204, a Machine Learning (ML) identification module 206, an entity attributes repository 208, an ML model extraction module 210, an ML model repository 212, a model creation module 214, a model training module 216, and a model accuracy testing module 218.

Data 220 is received by the entity identification device 102. The data 220 may include, but is not limited to images, text, or sensor data. The data 220 may include a plurality of entities. An entity, for example, may include, but is not limited to a character, an animal, an object, or a human. The character, for example, may include but is not limited to a digit, a symbol, or an alphabet. The data 220 may include a plurality of entities. For each of the plurality of entities, the entity identification module 202 may check the ML model repository 212 to identify a relevant ML model that is trained to identify that particular entity.

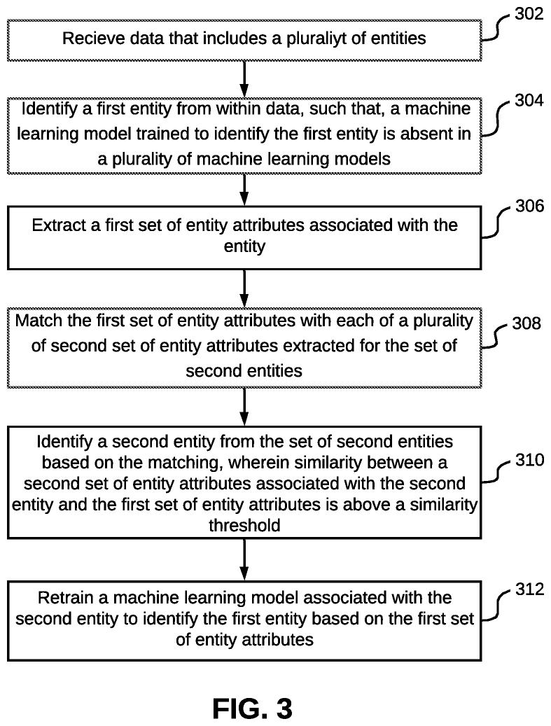

The ML model repository 212 may include a plurality of machine learning models that may be created and trained to identify one or more entities from a set of second entities. Each of the plurality of machine learning models may be assigned one of a plurality of categories, for example, machine learning models for complex entities, machine learning models for simple entities, and machine learning models for entities having medium complexity. This is further explained in detail in conjunction with FIG. 3. The entity identification module 202 may identify a first entity from within the data, such that, a machine learning model trained to identify the first entity is absent in the ML model repository 212.

Once the first entity is identified, the attribute extraction module 204 may extract a first set of entity attributes associated with the first entity. In an embodiment, when the data 220 is in the form of an image, the first set of entity attributes may be extracted from the image using image processing and feature extracting algorithms. Examples of such algorithm may include, but are not limited to SIFT™ or SURF™. Thereafter, the attribute extraction module 204 shares the first set of entity attributes with the ML identification module 206.

An attribute matching module 222 in the ML identification module 206 matches the first set of entity attributes with each of a plurality of second set of entity attributes stores in the entity attributes repository 208. The plurality of second set of entity attributes are extracted for the set of second entities. Entity attributes for a second entity may include one or more features that are descriptive of the second entity. In an embodiment, when the second entity is a character, entity attributes may include one or more of, but is not limited to a size of the character, a font of the character, a style associated with the character, a thickness of the character, a color of the character, or a geometrical shape of the character.

Based on the matching, a similarity determining module 224 determines similarity between the first set of entity attributes and each of the plurality of second set of entity attributes. Thereafter, the similarity determining module 224 identifies a second entity from the set of second entities based on the matching, such that, similarity between the second set of entity attributes associated with the second entity and the first set of entity attributes is above a similarity threshold. This is further explained in detail in conjunction with FIG. 3.

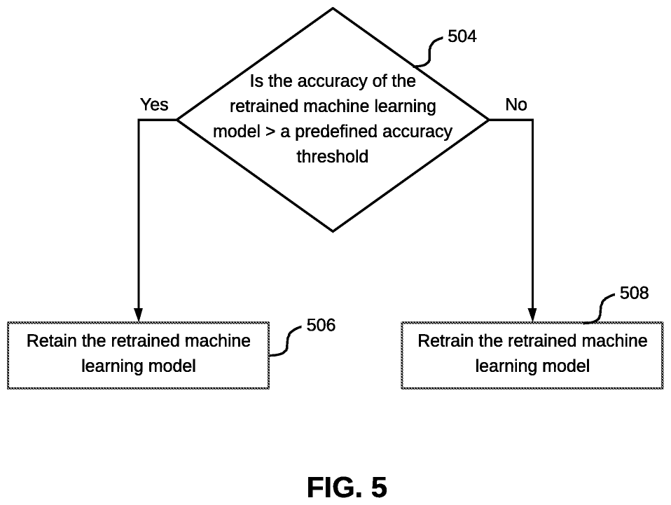

Once the second entity is identified, the ML model extraction module 210 may extract a machine learning algorithm trained for and associated with the second entity, from the ML model repository 212. Thereafter, the model training module 216 may train the machine learning model associated with the second entity to identify the first entity based on the first set of entity attributes. This is further explained in detail in conjunction with FIG. 3. The model accuracy testing module 218 may then test the accuracy of the trained machine learning model. This is further explained in detail in conjunction with FIG. 5.

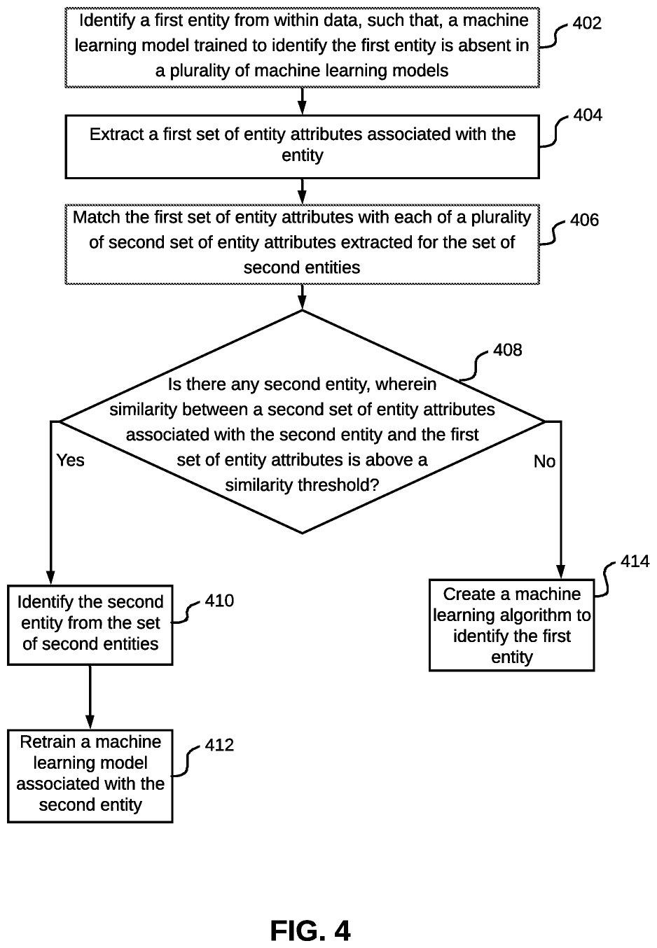

If the similarity determining module 224 is not able to identify any second entity, for which, the similarity is above the similarity threshold, the model creation module 214 may create a machine learning algorithm to identify the first entity. The model accuracy testing module 218 may then test the accuracy of the machine learning model. This is further explained in detail in conjunction with FIG. 4.

Referring now to FIG. 3, a flowchart of a method for identifying an existing machine learning model and retraining the existing machine learning model for detecting new entities is illustrated, in accordance with an embodiment. An entity, for example, may include, but is not limited to a character, an animal, an object, or a human. The character, for example, may include but is not limited to a digit, a symbol, or an alphabet. A plurality of machine learning models may be created and trained to identify one or more entities from a set of second entities. By way of an example, a machine learning model may be trained to identify “dogs,” while another machine learning model may be trained to identify “cats.” The plurality of machine leaning models may be stored in the ML model repository 212. Each of the plurality of machine learning models may be assigned one of a plurality of categories, for example, machine learning models for complex entities, machine learning models for simple entities, and machine learning models for entities having medium complexity.

Complexity of an entity may be determined based on various entity attributes associated with the entity. Entity attributes for an entity may include one or more features that are descriptive of the entity. In an embodiment, when the entity is a character, entity attributes may include one or more of, but is not limited to a size of the character, a font of the character, a style associated with the character, a thickness of the character, a color of the character, or a geometrical shape of the character.

At step 302, data (for example, the data 220) may be received by the entity identification device 102 in order to identify one or more of a plurality of entities in the data. The data may include, but is not limited to images, text, or sensor data. For each of the plurality of entities, the entity identification device 102 may check the ML model repository 212 to identify a relevant ML model that is trained to identify that particular entity. At step 304, the entity identification device 102 may identify a first entity from within the data, such that, a machine learning model trained to identify the first entity is absent in the plurality of machine learning models. In other words, the ML model repository 212 may not include a machine learning model that is trained to identify the first entity.

At step 306, the entity identification device 102 extracts a first set of entity attributes associated with the entity. In an embodiment, when the data is in the form of an image, the first set of entity attributes may be extracted from the image using image processing and feature extracting algorithms. Examples of such algorithm may include, but are not limited to SIFT™ or SURF™.

At step 308, the entity identification device 102 matches the first set of entity attributes with each of a plurality of second set of entity attributes extracted for the set of second entities. Entity attributes for a second entity may include one or more features that are descriptive of the second entity. In an embodiment, when the second entity is a character, entity attributes may include one or more of, but is not limited to a size of the character, a font of the character, a style associated with the character, a thickness of the character, a color of the character, or a geometrical shape of the character. The plurality of second set of entity attributes may be stored in the entity attributes repository 208.

The first set of entity attributes are matched with each of the plurality of second set of entity attributes extracted for the set of second entities in order to determine similarity between the first set of entity attributes and each of the plurality of second set of entity attributes. In an embodiment, a type of the first entity is matched with various types associated with the set of second entities. By way of an example, when the first entity is a character, only those second entities that are characters would be evaluated to determine similarity between the first set of entity attributes and each of the second set of entity attributes associated with these second entities, that are characters.

At step 308, the entity identification device 102 identifies a second entity from the set of second entities based on the matching, such that, similarity between the second set of entity attributes associated with the second entity and the first set of entity attributes is above a similarity threshold. Additionally, the similarity determined for the second entity when matched with the first entity may be the highest amongst the second set of entities. The similarity threshold may be defined by an administrator and may be modified as and when required. By way of an example, when the first entity is a digit, entity attributes that may include one or more of size, font, style, or thickness of the digit may be matched with one or more of size, font, style, or thickness of all digits in the second set of entities. In an embodiment, the similarity may be determined based on attribute complexity associated with the first entity. In other words, a second entity that is closest in attribute complexity to the first entity, may be identified at step 308.

Once the second entity is identified, a machine learning algorithm trained for and associated with the second entity may be extracted from the ML model repository 212. At step 310, the entity identification device 102 trains the machine learning model associated with the second entity to identify the first entity based on the first set of entity attributes. In order to train the machine learning model, data samples similar to the data received at step 302 may be used. Thereafter, accuracy of the trained machine learning model may be tested. This is further explained in detail in conjunction with FIG. 5.

Referring now to FIG. 4, a flowchart of a method for identifying an existing machine learning model or creating a new machine learning model for detecting new entities is illustrated, in accordance with an embodiment. At step 402, a first entity is identified from within received data, such that, a machine learning model trained to identify the first entity is absent in a plurality of machine learning models. In other words, the ML model repository 212 may not include a machine learning model that is trained to identify the first entity. At step 404, a first set of entity attributes associated with the entity are extracted. At step 406, the first set of entity attributes are matched with each of a plurality of second set of entity attributes extracted for the set of second entities. This has already been explained in conjunction with FIG. 3.

At step 408, a check is performed to determine if there is any second entity, such that, similarity between a second set of entity attributes associated with the second entity and the first set of entity attributes is above a similarity threshold. If there is such a second identity, at step 410, the second entity is identified from the set of second entities. At step 412, a machine learning model associated with the second entity is retrained to identify the first entity. This has already been explained in conjunction with FIG. 3.

Referring back to step 408, if there is no such second identity, at step 414, a machine learning algorithm is created to identify the first entity. In other words, when similarity between each of the second set of entity attributes associated with each of the set of second entities and the first set of entity attributes is below or equal to the similarity threshold, the machine learning algorithm is created.

Referring now to FIG. 5, a flowchart of a method for determining accuracy of a machine learning model and accordingly retaining or retraining the retrained machine learning model, in accordance with an embodiment. Once the machine learning mode has been retrained, at step 502, a check is performed to determine if the accuracy of the retrained machine learning model (trained to identify the first entity) is greater than a predefined accuracy threshold. The predefined accuracy threshold may be the accuracy of the retrained machine learning model in identifying the first entity. In an embodiment, the accuracy of the retrained machine learning model in identifying the first entity may be compared with accuracy of each of the plurality of machine learning model in identifying associated second entity from the set of second entities.

Referring back to step 502, when the accuracy of the retrained machine learning model is greater than the predefined accuracy threshold, the retrained machine learning model is retained for further use at step 504. However, when the accuracy of the retrained machine learning model is less than or equal to the predefined accuracy threshold, the retrained machine learning model is further retrained at step 506.

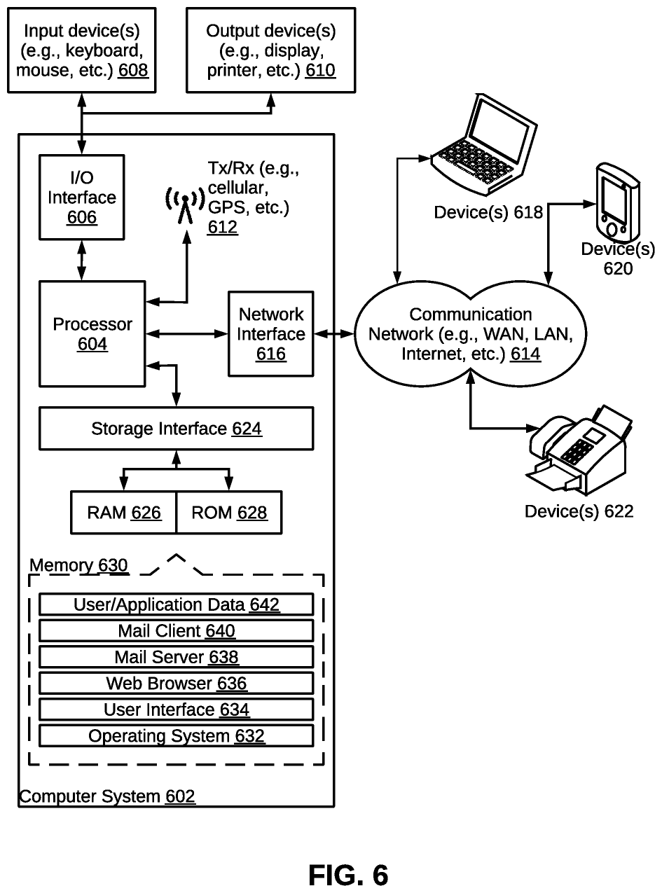

Referring now to FIG. 6, a block diagram of an exemplary computer system 602 for implementing various embodiments is illustrated. Computer system 602 may include a central processing unit (“CPU” or “processor”) 604. Processor 604 may include at least one data processor for executing program components for executing user or system-generated requests. A user may include a person, a person using a device such as such as those included in this disclosure, or such a device itself. Processor 604 may include specialized processing units such as integrated system (bus) controllers, memory management control units, floating point units, graphics processing units, digital signal processing units, etc. Processor 604 may include a microprocessor, such as AMD ATHLON microprocessor, DURON microprocessor OR OPTERON microprocessor, ARM's application, embedded or secure processors, IBM POWERPC, INTEL'S CORE processor, ITANIUM processor, XEON processor, CELERON processor or other line of processors, etc. Processor 604 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 604 may be disposed in communication with one or more input/output (I/O) devices via an I/O interface 606. I/O interface 606 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (for example, code-division multiple access (CDMA), high-speed packet access (HSPA+), global system for mobile communications (GSM), long-term evolution (LTE), WiMax, or the like), etc.

Using I/O interface 606, computer system 602 may communicate with one or more I/O devices. For example, an input device 608 may be an antenna, keyboard, mouse, joystick, (infrared) remote control, camera, card reader, fax machine, dongle, biometric reader, microphone, touch screen, touchpad, trackball, sensor (for example, accelerometer, light sensor, GPS, gyroscope, proximity sensor, or the like), stylus, scanner, storage device, transceiver, video device/source, visors, etc. An output device 610 may be a printer, fax machine, video display (for example, cathode ray tube (CRT), liquid crystal display (LCD), light-emitting diode (LED), plasma, or the like), audio speaker, etc. In some embodiments, a transceiver 612 may be disposed in connection with processor 604. Transceiver 612 may facilitate various types of wireless transmission or reception. For example, transceiver 612 may include an antenna operatively connected to a transceiver chip (for example, TEXAS INSTRUMENTS WILINK WL1286 transceiver, BROADCOM BCM4550IUB 8 transceiver, INFINEON TECHNOLOGIES X-GOLD 618-PMB9800 transceiver, or the like), providing IEEE 802.6a/b/g/n, Bluetooth, FM, global positioning system (GPS), 2G/3G HSDPA/HSUPA communications, etc.

In some embodiments, processor 604 may be disposed in communication with a communication network 614 via a network interface 616. Network interface 616 may communicate with communication network 614. Network interface 616 may employ connection protocols including, without limitation, direct connect, Ethernet (for example, twisted pair 50/500/5000 Base T), transmission control protocol/internet protocol (TCP/IP), token ring, IEEE 802.11a/b/g/n/x, etc. Communication network 614 may include, without limitation, a direct interconnection, local area network (LAN), wide area network (WAN), wireless network (for example, using Wireless Application Protocol), the Internet, etc. Using network interface 616 and communication network 614, computer system 602 may communicate with devices 618, 620, and 622. These devices may include, without limitation, personal computer(s), server(s), fax machines, printers, scanners, various mobile devices such as cellular telephones, smartphones (for example, APPLE IPHONE smartphone, BLACKBERRY smartphone, ANDROID based phones, etc), tablet computers, eBook readers (AMAZON KINDLE ereader, NOOK tablet computer, etc.), laptop computers, notebooks, gaming consoles (MICROSOFT XBOX gaming console, NINTENDO DS gaming console, SONY PLAYSTATION gaming console, etc.), or the like. In some embodiments, computer system 602 may itself embody one or more of these devices.

In some embodiments, processor 604 may be disposed in communication with one or more memory devices (for example, RAM 626, ROM 628, etc.) via a storage interface 624. Storage interface 624 may connect to memory 630 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 630 may store a collection of program or data repository components, including, without limitation, an operating system 632, user interface application 634, web browser 636, mail server 638, mail client 640, user/application data 642 (for example, any data variables or data records discussed in this disclosure), etc. Operating system 632 may facilitate resource management and operation of computer system 602. Examples of operating systems 632 include, without limitation, APPLE MACINTOSH OS X platform, UNIX platform, Unix-like system distributions (for example, Berkeley Software Distribution (BSD), FreeBSD, NetB SD, OpenB SD, etc.), LINUX distributions (for example, RED HAT, UBUNTU, KUBUNTU, etc.), IBM OS/2 platform, MICROSOFT WINDOWS platform (XP, Vista/7/8, etc.), APPLE IOS platform, GOOGLE ANDROID platform, BLACKBERRY OS platform, or the like. User interface 634 may facilitate display, execution, interaction, manipulation, or operation of program components through textual or graphical facilities. For example, user interfaces may provide computer interaction interface elements on a display system operatively connected to computer system 602, such as cursors, icons, check boxes, menus, scrollers, windows, widgets, etc. Graphical user interfaces (GUIs) may be employed, including, without limitation, APPLE Macintosh operating systems' AQUA platform, IBM OS/2 platform, MICROSOFT WINDOWS platform (for example, AERO platform, METRO platform, etc.), UNIX X-WINDOWS, web interface libraries (for example, ACTIVEX platform, JAVA programming language, JAVASCRIPT programming language, AJAX programming language, HTML, ADOBE FLASH platform, etc.), or the like.

In some embodiments, computer system 602 may implement a web browser 636 stored program component. Web browser 636 may be a hypertext viewing application, such as MICROSOFT INTERNET EXPLORER web browser, GOOGLE CHROME web browser, MOZILLA FIREFOX web browser, APPLE SAFARI web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE FLASH platform, JAVASCRIPT programming language, JAVA programming language, application programming interfaces (APIs), etc.

In some embodiments, computer system 602 may implement a mail server 638 stored program component. Mail server 638 may be an Internet mail server such as MICROSOFT EXCHANGE mail server, or the like. Mail server 638 may utilize facilities such as ASP, ActiveX, ANSI C++/C#, MICROSOFT.NET programming language, CGI scripts, JAVA programming language, JAVASCRIPT programming language, PERL programming language, PHP programming language, PYTHON programming language, WebObjects, etc. Mail server 638 may utilize communication protocols such as internet message access protocol (IMAP), messaging application programming interface (MAPI), Microsoft Exchange, post office protocol (POP), simple mail transfer protocol (SMTP), or the like. In some embodiments, computer system 602 may implement a mail client 640 stored program component. Mail client 640 may be a mail viewing application, such as APPLE MAIL client, MICROSOFT ENTOURAGE mail client, MICROSOFT OUTLOOK mail client, MOZILLA THUNDERBIRD mail client, etc.

In some embodiments, computer system 602 may store user/application data 642, such as the data, variables, records, etc. as described in this disclosure. Such data repositories may be implemented as fault-tolerant, relational, scalable, secure data repositories such as ORACLE data repository OR SYBASE data repository. Alternatively, such data repositories may be implemented using standardized data structures, such as an array, hash, linked list, struct, structured text file (for example, XML), table, or as object-oriented data repositories (for example, using OBJECTSTORE object data repository, POET object data repository, ZOPE object data repository, etc.). Such data repositories may be consolidated or distributed, sometimes among the various computer systems discussed above in this disclosure. It is to be understood that the structure and operation of the any computer or data repository component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Various embodiments provide method and device for identifying machine learning model for detecting entities. The proposed method and device are not limited to Optical Character Recognition (OCR). Moreover, the proposed method and device may be used in conjunction with a wide variety of applications for detecting misrecognized words. The proposed method and device are further capable of detecting misrecognized words on the basis of a spell-checking algorithm, a grammar checking algorithm, a natural language algorithm, or any combination thereof. The proposed method and device may be compatible with numerous other applications such as, but not limited to, predictive analysis, image classification, sentiment analysis or any other machine learning classification models.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for identifying a machine learning model for detecting entities from data, the method comprising:
identifying a first entity from within data, wherein a machine learning model trained to identify the first entity is absent in a plurality of machine learning models, wherein each of the plurality of machine learning models is trained to identify at least one entity from a set of second entities;
extracting a first set of entity attributes associated with the entity;
matching the first set of entity attributes with each of a plurality of second set of entity attributes extracted for the set of second entities;
identifying a second entity from the set of second entities based on the matching, wherein similarity between a second set of entity attributes associated with the second entity and the first set of entity attributes is above a similarity threshold; and
retraining a machine learning model associated with the second entity to identify the first entity based on the first set of entity attributes.

2. The method of claim 1, wherein the first entity and each of the second set of entities comprises at least one of a character, an animal, an object, a human, text, or sensor data.

3. The method of claim 2, wherein, when the first entity comprises a character, the first set of entity attributes comprises at least one of a size of the character, a font of the character, a style associated with the character, a thickness of the character, a color of the character or geometrical shapes part of the character.

4. The method of claim 1, wherein the first set of entity attributes comprises at least one feature descriptive of the first entity and each of the plurality of second set of entity attributes comprises at least one feature descriptive of an associated second entity in the second set of entities.

5. The method of claim 1 further comprising testing accuracy of the retrained machine learning model in identifying the first entity, wherein testing the accuracy comprises:
determining whether the accuracy of the retrained machine learning model is greater than a predefined accuracy threshold; and
retraining the retrained machine learning model, when the accuracy of the retrained machine learning model is less than the predefined accuracy threshold.

6. The method of claim 1 further comprising creating a machine learning algorithm to identify the first entity, wherein similarity between a second set of entity attributes associated with each of the second set of entities and the first set of entity attributes is below the similarity threshold.

7. An entity identification device for identifying a machine learning model for detecting entities from data, the entity identification device comprising:
a processor; and
a memory communicatively coupled to the processor, wherein the memory stores processor instructions, which, on execution, causes the processor to:
identify a first entity from within data, wherein a machine learning model trained to identify the first entity is absent in a plurality of machine learning models, wherein each of the plurality of machine learning models is trained to identify at least one entity from a set of second entities;
extract a first set of entity attributes associated with the entity;
match the first set of entity attributes with each of a plurality of second set of entity attributes extracted for the set of second entities;
identify a second entity from the set of second entities based on the matching, wherein similarity between a second set of entity attributes associated with the second entity and the first set of entity attributes is above a similarity threshold; and
retrain a machine learning model associated with the second entity to identify the first entity based on the first set of entity attributes.

8. The entity identification device of claim 7, wherein the first entity and each of the second set of entities comprises at least one of a character, an animal, an object, a human, text, or sensor data.

9. The entity identification device of claim 8, wherein, when the first entity comprises a character, the first set of entity attributes comprises at least one of a size of the character, a font of the character, a style associated with the character, a thickness of the character, a color of the character or geometrical shapes part of the character.

10. The entity identification device of claim 7, wherein the first set of entity attributes comprises at least one feature descriptive of the first entity and each of the plurality of second set of entity attributes comprises at least one feature descriptive of an associated second entity in the second set of entities.

11. The entity identification device of claim 7, wherein the processor instructions further cause the processor to test accuracy of the retrained machine learning model in identifying the first entity, wherein to test the accuracy the processor instructions further cause the processor to:
determine whether the accuracy of the retrained machine learning model is greater than a predefined accuracy threshold; and
retrain the retrained machine learning model, when the accuracy of the retrained machine learning model is less than the predefined accuracy threshold.

12. The entity identification device of claim 1, further wherein the processor instructions further cause the processor to create a machine learning algorithm to identify the first entity, wherein similarity between a second set of entity attributes associated with each of the second set of entities and the first set of entity attributes is below the similarity threshold.

13. A non-transitory computer-readable storage medium comprising a set of computer-executable instructions causing a computer comprising one or more processors to perform steps comprising:
identifying a first entity from within data, wherein a machine learning model trained to identify the first entity is absent in a plurality of machine learning models, wherein each of the plurality of machine learning models is trained to identify at least one entity from a set of second entities;
extracting a first set of entity attributes associated with the entity;
matching the first set of entity attributes with each of a plurality of second set of entity attributes extracted for the set of second entities;
identifying a second entity from the set of second entities based on the matching, wherein similarity between a second set of entity attributes associated with the second entity and the first set of entity attributes is above a similarity threshold; and
retraining a machine learning model associated with the second entity to identify the first entity based on the first set of entity attributes.
